(19) United States
(12) Patent Application Publication
(10) Pub. No.: US 2023/0289986 A1
(43) Pub. Date: Sep. 14, 2023

(54) RANGE FINDING DEVICE, CONTROL METHOD FOR RANGE FINDING DEVICE, AND STORAGE MEDIUM

(71) Applicant: CANON KABUSHIKI KAISHA, Tokyo (JP)

(72) Inventors: Manabu Abe, Tokyo (JP); Hiroshi Yano, Kanagawa (JP)

(21) Appl. No.: 18/178,164

(22) Filed: Mar. 3, 2023

(30) Foreign Application Priority Data
Mar. 10, 2022 (JP) 2022-036883

(51) Int. Cl. G06T 7/55

(52) U.S. Cl. CPC G06T 7/55; G06T 2207/10012; G06T 2207/30248

(57) ABSTRACT

A range finding device that can suppress a reduction in range finding accuracy caused by road surface conditions is provided. A range finding device comprising: a memory storing instructions; and a processor executing the instructions causing the range finding device to: calculate a distance between a moving object and an object, acquire a road surface condition, and acquire a running state of the moving object, wherein the processor calculates the distance from the object according to the road surface condition and the running condition.

### BACKGROUND OF THE INVENTION

### Field of the Invention

The present invention relates to a range finding device, a control method for the range finding device, and a storage medium.

### Description of the Related Art

Various range finding devices that are mounted on a moving object and calculate a distance from an object are generally known. For example, there is a range finding device that calculates a distance from a vehicle that is in front of it by using a single imaging device mounted on a vehicle, and a range finding device having a stereo camera that calculates a distance by using a plurality of imaging devices. Additionally, range finding devices in which an imaging device is not used such as LiDAR, which performs range finding by using laser light, RADAR, which uses radio waves, and the like are known. When vibrations occur due to road surface conditions during range finding, the range finding accuracy in these range finding devices may decrease due to the blurring of images, the displacement of the vehicle and the range finding device, or the like. Accordingly, a technique in which vibrations are detected by an acceleration detection unit, and the reliability is determined based on the measured value has been proposed, as is disclosed in Japanese Patent Application Laid-Open No. 2009-174898.

However, in the above conventional example, when the detected value of the acceleration detection unit exceeds a predetermined threshold, the measurement value acquired from the sensor is not used. That is, for example, there are cases in which bumps continue over a wide area on the road during the distance measurement distance using the range finding device. In this case, when the detected acceleration value detected using a vehicle travelling on the road exceeds a predetermined threshold, the measurement value resulting from range finding is not used during the period of time. Therefore, during the period of time in which the detected acceleration value exceeds the predetermined threshold, the measurement value resulting from range finding does not exist, and the range finding accuracy may be reduced.

### SUMMARY OF THE INVENTION

The present invention has been made in view of the above concern, and provides a range finding device that can suppress the reduction in range finding accuracy caused by road surface conditions.

In order to achieve the above object, a range finding device in the present invention comprises: a memory storing instructions; and a processor executing the instructions causing the range finding device to: calculate a distance between a moving object and an object, acquire a road surface condition, and acquire a running state of the moving object, wherein the processor calculates a distance from the object according to the road surface condition and the running condition.

Further features of the present invention will become apparent from the following description of exemplary embodiments (with reference to the attached drawings).

### BRIEF DESCRIPTION OF THE DRAWINGS

FIG. 1 is a diagram schematically showing a configuration of the first embodiment.

FIG. 2 is a block diagram showing a forward range finding device and its surroundings.

FIG. 3 is a flowchart showing a range finding operation flow of the forward range finding device according to the first embodiment.

FIG. 4A and FIG. 4B are diagrams showing acquisition timing of distance information in bumpy sections on a road.

FIG. 5 is a flowchart that is further related to shutter speed changes during the generation of images according to the second embodiment.

FIG. 6A and FIG. 6B are diagrams showing the relation between the image generating timing (thick line) and the shutter speed at an image output frequency (frame rate) in the bumpy section on the road.

FIG. 7 is a flowchart showing a combination of changes to the distance information calculation method and changes to the shutter speed according to the third embodiment.

### DESCRIPTION OF THE EMBODIMENTS

Embodiments of the present invention will now be described with reference to the drawings. Note that the embodiments below do not limit the claimed invention, and not all of the combinations of features described in the embodiments are essential to the means for solving the present invention.

### First Embodiment

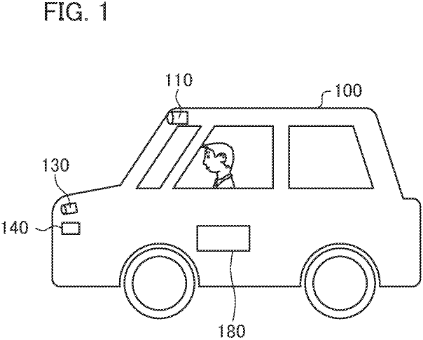

The first embodiment of the present invention will be described. FIG. 1 is a diagram schematically showing a configuration of the first embodiment. A vehicle 100 is an example of a moving object. The vehicle 100 includes a forward range finding device 110 that measures a distance in front of the vehicle 100, a road surface condition detecting unit 130 that detects a road surface condition, a self-vehicle condition detecting unit 140 that detects a condition of the vehicle 100, and a vehicle control unit 180 that controls the vehicle 100. Note that, in the present embodiment, although a state of vibration occurring in the vehicle 100 is detected (predicted) by the two units of the road surface condition detecting unit 130 and the self-vehicle condition detecting unit 140, a configuration in which only one of them is used may also be employed.

The forward range finding device 110 is a device for measuring a distance from moving objects such as vehicles that are in front of the vehicle 100, and the like. The forward range finding device 110 in the present embodiment has a configuration in which an imaging unit 220 having an imaging element 222 is used. Here, although there are various known methods for determining the distance information for an object based on the image information of a single camera, any method may be used in the present embodiment. For example, a DAF camera that can simultaneously acquire a plurality of RGB images and calculate the distance may be adopted. DAF is an abbreviation for “Dual Pixel AutoFocus”, and a DAF camera is a camera that has a function of acquiring a plurality of images having parallax. Additionally, a camera referred to as a “stereo camera” in which two cameras are used may be used. The imaging unit 220 in the present embodiment is an example of an imaging unit that captures a plurality of images having parallax.

Here, the forward range finding device 110 in the present embodiment shows an example of a distance calculating unit that calculates the distance between an object and a moving object, and the present invention is not necessarily limited to using an imaging device. For example, devices using light or radio waves, such as LiDAR and RADAR that have units for emitting light or radio waves by themselves may be used. Alternatively, a range finding device based on the SONAR method in which sound waves are used may also be used. Note that LiDAR is an abbreviation for “Light Detection and Ranging”, and RADAR is an abbreviation for “Radio Detecting and Ranging”. Additionally, SONAR is an abbreviation for “Sound Navigation and Ranging”. Additionally, although in the present embodiment, the forward range finding device 110 is illustrated, the device is not limited to range finding devices that perform range finding in the front direction, and range finding devices that perform range finding in the rear and side directions may also be used.

The road surface condition detecting unit 130 is a unit for detecting a road surface condition in front of the vehicle 100, and can detect, for example, steps and surface conditions, and obstacles on the road. Examples of the detection method include image recognition using an imaging device and a method that uses light or radio waves such as LiDAR or RADAR having a unit that emits light or radio waves by itself may be used. Additionally, a unit using a gyro sensor, or an acceleration sensor may also be used as the road surface condition detecting unit 130. Furthermore, the forward range finding device 110 mounted on the vehicle 100 may be used for detecting the road surface condition. The influence on the vehicle 100, that is, in the present embodiment, the vibration on the vehicle 100, is predicted by using the road surface condition detecting unit 130. Thus, the road surface condition detecting unit 130 in the present embodiment is an example of a road surface condition acquisition unit that acquires the road surface condition.

The self-vehicle condition detecting unit 140 is a unit that detects vibrations occurring in the vehicle 100. Specifically, vibrations that occur in the vehicle 100 when the vehicle 100 passes over bumps on the road are detected. The state of the vehicle 100 that is detected by the self-vehicle condition detecting unit 140 is, for example, acceleration due to vibration and the like. Thus, the self-vehicle condition detecting unit 140 in the present embodiment is an example of a running state acquisition unit that acquires the running state of the moving object.

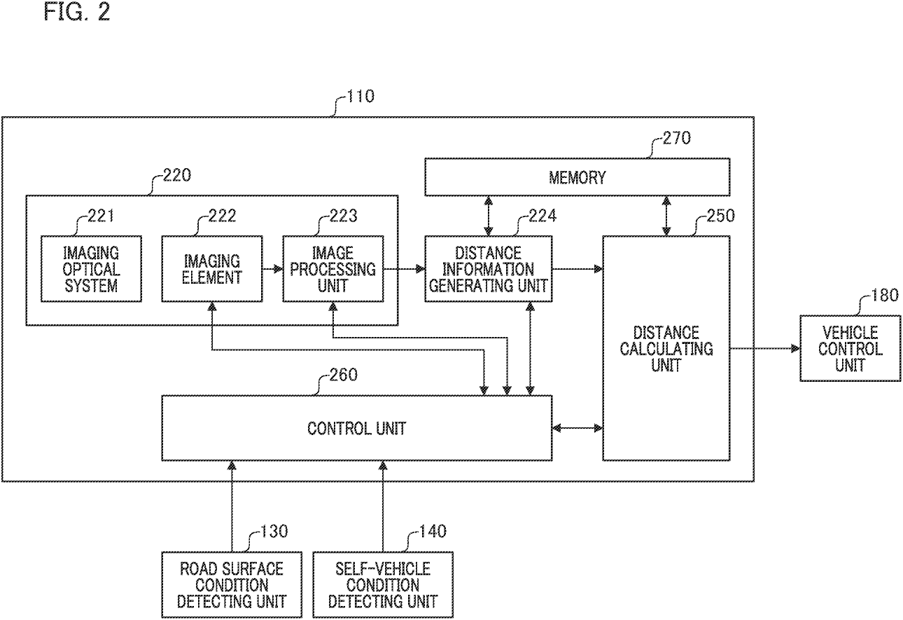

FIG. 2 is a block diagram showing the forward range finding device 110 and its surroundings. The forward range finding device 110 has the imaging unit 220, a distance information generating unit 224, a distance calculating unit 250, a control unit 260, and a memory 270. The control unit 260 includes a processor, for example, a CPU. The memory 270 includes a ROM, a RAM, and other storage units. Additionally, the imaging unit 220 has an imaging optical system 221, the imaging element 222, and an image processing unit 223.

The imaging optical system 221 is configured by a plurality of lens groups, and forms an object image in the external world on the imaging element 222. The imaging element 222 is configured by photoelectric conversion elements such as a CMOS and a CCD, photoelectrically converts the object image formed on the imaging element 222, and outputs a converted image signal to the image processing unit 223.

The image processing unit 223 generates the image data based on the image signal that has been transmitted and outputs the image data to the distance information generating unit 224. At this time, the number of images of the generated image data per unit time is defined as an image output frequency (frame rate) f. The distance information generating unit 224 generates distance information L that indicates a distance from a target object (for example, a vehicle in front of the moving vehicle) for each image data input at an image output frequency (frame rate) f, and outputs the distance information L to the distance calculating unit 250. The distance information generating unit 224 in the present embodiment is an example of a distance information generating unit.

The distance calculating unit 250 outputs distance information LL to the vehicle control unit 180 based on the road surface conditions that have been obtained from the road surface condition detecting unit 130 and the self-vehicle condition detecting unit 140, and the information related to the occurrence of vibrations in the vehicle 100. The distance information LL is obtained by performing averaging processing for a plurality of items of distance information L, based on the information related to the occurrence of vibrations on the vehicle 100. At this time, the averaged number is defined as the image averaged number n. Note that, the explanation below will be given on the assumption that, in the distance calculating unit 250 in the present embodiment, an object is estimated based on a single item of image information by a single camera and the distance is calculated based on its size.

Advantages and disadvantages resulting from using the road surface condition detecting unit 130 and the self-vehicle condition detecting unit 140 in the calculation by the distance calculating unit 250 will now be explained. In the present embodiment, for the sake of explanation, although a configuration in which two detection units are provided is used, a configuration may also be used in which only one of the detection units is provided, or a configuration in which the disadvantages in each of the detection units are complemented may also be used.

An advantage of the road surface condition detecting unit 130 is that, since the state of vibrations occurring in the vehicle 100 can be predicted in advance, the averaging processing for the distance information L in the distance calculating unit 250 that is described above can be effectively performed. A disadvantage of the road surface condition detection unit 130 is that, since the vibration state obtained by using the road surface condition detecting unit 130 is a prediction, the accuracy is lower than the case in which the self-vehicle condition detecting unit 140 is used. Additionally, there is also a limit to the range finding region of the road surface condition detecting unit 130. Furthermore, since some locations on the vehicle 100 are occupied by components of the vehicle 100, there are limitations to the placement location.

Examples of the advantages of the self-vehicle condition detecting unit 140 include that it can detect the actual vibration, and that there are fewer limitations to its placement location, unlike for the road surface condition detecting unit 130. A disadvantage of the self-vehicle condition detecting unit 140 is that a larger time lag may occur with respect to the desired processing completion time compared to the road condition detection unit 130. This is because the averaging processing for the distance information L in the distance calculating unit 250 is performed after the vibrations occur.

The control unit 260 controls the parameters for when the distance is calculated in the forward range finding device 110 according to the road surface conditions and the running conditions that the road surface condition detecting unit 130 has detected. The parameters that are controlled by the control unit 260 are, for example, the length of time for the averaging processing, the sampling interval, the frequency of distance measurement, and the distance measurement range during distance calculation. Each parameter will be described in detail below. The transfer of the signals for each block in FIG. 2 is performed via a control of the control unit 260.

Meanwhile, in general, it is known that the range finding accuracy of a range finding device mounted on a moving object decreases when the moving object vibrates due to bumps on the road surface, and the like. Range finding performance decreases due to changes in the positional relation of the moving object and the range finding device relative to the road surface during this vibration, and the occurrence of blurring on the images in the case of a range finding device using an imaging element, and other factors. In the present embodiment, a configuration will be explained in which a reduction in range finding accuracy is suppressed as much as possible during the occurrence of vibrations in the vehicle 100 due to steps on the road surface and the like.

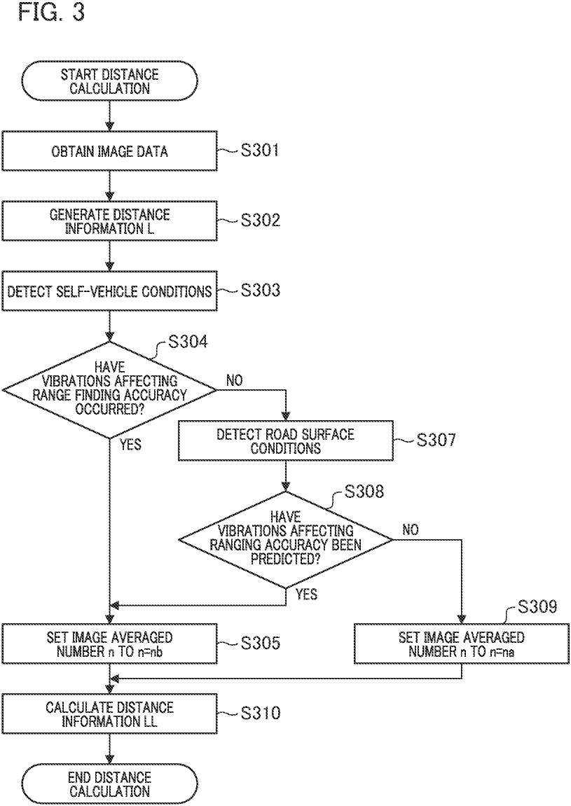

FIG. 3 is a flow chart showing the range finding operation flow of the forward range finding device 110 according to the first embodiment. The flowchart will be explained below. The processes shown in the flowchart are realized by, for example, the control unit 260 reading out a program stored on a storage device (not illustrated) onto a RAM, and executing the program .

When the distance calculating unit 250 starts distance calculation, in step S301, the control unit 260 causes the image processing unit 223 in the imaging unit 220 to generate image data. Accordingly, image data are acquired. The image data are output to the distance information generating unit 224.

In step S302, the control unit 260 causes the distance information generating unit 224 to extract the object from the image data and recognize what the object is. When the distance information generating unit 224 recognizes the object, the control unit 260 causes the distance information generation unit 224 to acquire size data when a standard model of the object is at a predetermined distance. Note that size data when the standard model of the object is at a predetermined distance is stored in the memory 270 in advance. For example, when the object is a traffic light, size data imaged by the imaging unit 220 when the standard size-traffic light is at a predetermined distance is stored in the memory 270 in advance. In this configuration, the distance information generating unit 224 compares the actual size of the object in the image data to the size data, and generates the distance information L, which is distance information indicating the distance to the object. The distance information L is output to the distance calculating unit 250.

In step S303, the control unit 260 causes the self-vehicle condition detecting unit 140 to perform detection and obtains the vibration state of the vehicle 100, such as the amplitude and frequency of the vibration.

In step S304, the control unit 260 determines whether or not vibrations that affect the range finding accuracy are being generated. Specifically, the vibration state detected in step S303 is compared to a predetermined value. When, as the result of the comparison, the control unit 260 determines that the vibration state affects the range finding accuracy, the process of step S305 is executed. In step S305, the control unit 260 sets the image averaged number n to the value of the corresponding image averaged number n, according to the vibration state of the vehicle 100.

In contrast, in step S304, the vibration state is compared to the predetermined value, and when the control unit 260 determines that the vibration state does not affect the range finding accuracy, the process of step S307 is executed. In step S307, the control unit 260 detects the forward road condition by using the road surface condition detecting unit 130. Subsequently, the process of step S308 is executed.

In step S308, the control unit 260 predicts what kind of vibration will occur. The prediction is performed based on the information regarding road surface conditions detected by using the road surface condition detecting unit 130, such as bumps on the road surface and the sizes thereof, surface conditions (the way in which the road surface is uneven), the distances between them, and the travelling speed of the vehicle 100. The control unit 260 compares the predicted vibration state and the predetermined value. When, as the result of the comparison, the control unit 260 determines that a vibration that will affect the accuracy of distance measurement is predicted, the process of step S305 is executed.

In contrast, in step S308, the predicted vibration state is compared to a predetermined value, and when the control unit 260 determines that the vibration will not affect the range finding accuracy, the process of step S309 is executed. In step S309, the image averaged number n is set to the image averaged number na, which is a normal value (initial value). After the process of step S305 or step S309, the process of step S310 is executed.

In step S310, the final distance information LL is calculated in step S310, based on the image averaged number n that was changed in step S305 and step S309. Subsequently, the distance calculation operation of the distance calculating unit 250 ends. Note that, in the present embodiment, the distance information LL that the distance calculating unit 250 calculates is an example of the calculated distance obtained by the forward range finding device 110.

Here, in the present embodiment, an image averaged number nb for when vibrations occur is set higher than the image averaged number na in the normal state (initial value) (image averaged number na < image averaged number nb). The effect resulting from this will be described.

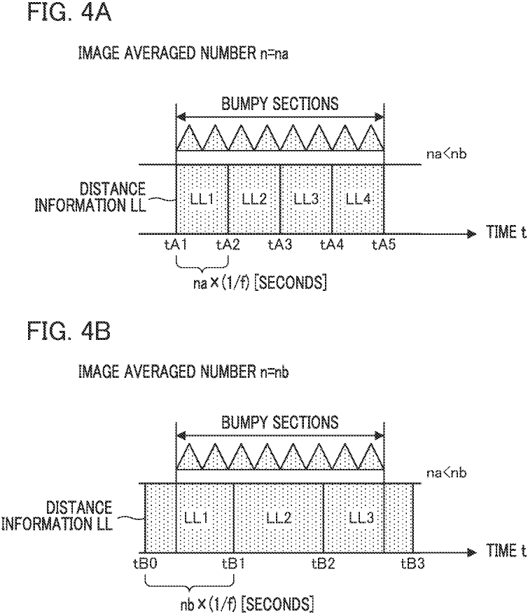

FIG. 4A and FIG. 4B are diagrams showing the acquisition timing of the distance information LL in the bumpy sections on the road. The distance information LL is output at the timing of a vertical line crossing a time axis. FIG. 4A shows the case of the image averaged number na, and FIG. 4B shows the case of the image averaged number nb. The condition image averaged number na < image averaged number nb is satisfied. All other conditions are the same.

In FIG. 4A, the output of the distance information LL is performed every na x(⅟f) seconds, in which the image averaged number n = image averaged number na is set corresponding to the image output frequency (frame rate) f. In contrast, in FIG. 4B, the output of the distance information LL is performed every nb×(⅟f) seconds, in which the image averaged number n=the image averaged number nb is set. In the present embodiment, image averaged number na < image averaged number nb is set, as was described above. Therefore, the image averaged number n is greater in the image averaged number n = image averaged number nb in FIG. 4B,, compared to the image averaged number n = image averaged number na in FIG. 4A, and the interval (frequency) at which the distance information LL is acquired is shorter. That is, the condition frequency f/na > f/nb is satisfied.

In FIG. 4A, distance information LL1 to LL4 are all distance information from within the bumpy sections, and vibration occurs in the vehicle 100, resulting in a decrease in the range finding accuracy. Specifically, in FIG. 4A, the range finding accuracy decreases in all the distance information LL1 to LL4 obtained at tA2 to tA5.

In contrast, in FIG. 4B, with respect to the distance information LL2 obtained at tB2, since all of the distance information L are from within the bumpy sections, the range finding accuracy decreases due to the influence of vibrations. In contrast, with respect to the distance information LL1 and the distance information LL3 that are obtained at tB1 and tB3, distance information L from outside of the bumpy sections is included. That is, in the case of FIG. 4B, the time length for the averaging processing is long, and distance information L from outside of the bumpy sections is included. Accordingly, the range finding accuracy improves as compared to the distance information LL2. Thus, in the bumpy sections (when vibration occurs on the vehicle 100), when the image averaged number nb is set, the frequency at which the distance information LL is acquired becomes lower compared to the case in which the image averaged number na is set, but the range finding accuracy of the distance information LL improves. As described above, this is the case in which the relation of the image averaged numbers n is the image averaging number na < the image averaged number nb.

The value of the image averaged number nb may be appropriately set according to the waveforms of the amplitude and frequency and the like, and the length of time of the vibrations that occur or the vibrations that are predicted. For example, when the bumpy section continues (when the vibration generation time continues for a longer period of time), the image averaged number nb is set to be higher (the time interval for the distance information L used for averaging is set to be longer). Additionally, in the present embodiment, although averaging of the distance information L is performed, the present invention is not limited thereto. For example, the frequency for the range finding (frequency for the distance measurement) itself may be changed by thinning out images depending on the generation status of the vibrations, without using the distance information L during generation of vibrations instead of averaging. Alternatively, the sampling intervals for the images may be changed, instead of thinning out images.

Thus, with respect to the range finding accuracy during vibration generation in the vehicle 100, a means for suppressing the reduction in range finding accuracy by changing the distance information calculation method has been explained. In the present embodiment, although a configuration that uses the imaging unit 220 is used, the present invention is not limited thereto. For example, a range finding device that uses laser light, radio waves, or sound waves may also be used. In this case, it is sufficient if the image output frequency (frame rate) f in the present embodiment is replaced with the range finding frequency of the range finding device, and the image averaged number n is replaced with the average number according to the range finding device.

### Second Embodiment

A method for suppressing a reduction in range finding accuracy according to the second embodiment will be described. The same reference numerals are assigned to the configurations that are the same as the configurations in the above-described embodiment,, and descriptions thereof will be omitted.

The imaging unit 220 has a configuration in which an exposure time, which is referred to as a “shutter speed”, is adjusted (changed) when images are generated. In the present embodiment, an explanation will be given in which the shutter speed is adjusted by a method for controlling the electron accumulation operation and reading operation in the imaging element 222, which is generally referred to as an “electronic shutter method”. However, the shutter speed can also be adjusted by a mechanical exposure control unit, which is referred to as a “mechanical shutter”.

The relation between the shutter speed and the exposure time is that a high shutter speed = a short exposure time. When the exposure time is shortened by increasing the shutter speed (by speeding up the shutter speed), the amount of light accumulated in the imaging element 222 is reduced. In this case, image data with an appropriate exposure amount can be obtained by adjusting an aperture mechanism for adjusting an amount of light entering from a lens and adjusting a gain for amplifying image signals from the imaging element 222. Hence, by increasing the shutter speed, it possible to perform range finding using image data with a short exposure time in which the blurring of an object image is made as low as possible

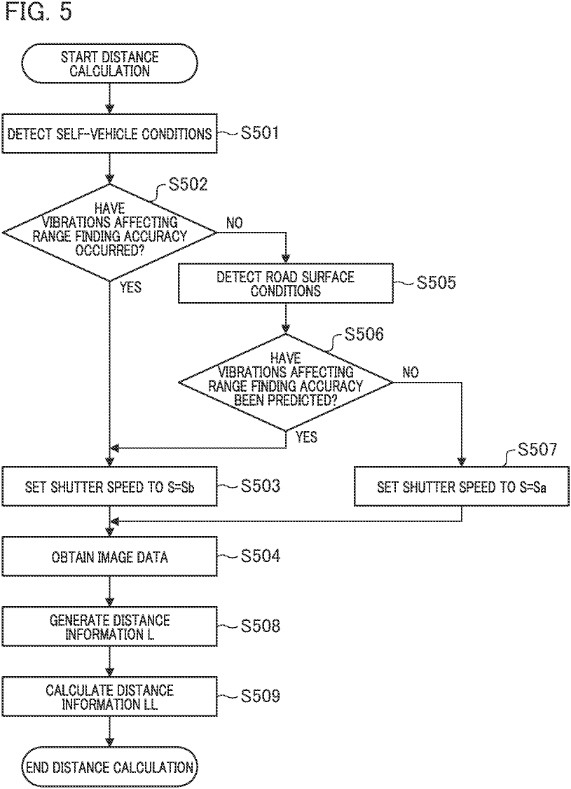

FIG. 5 is a flowchart related to shutter speed changes during image generation according to the second embodiment. The flowchart will be explained below. Note that the details of a shutter speed S in the drawing will be described below, and the normal shutter speed is a shutter speed Sa. In the present embodiment, a shutter speed Sb, which is higher than the shutter speed Sa, is set depending on the state of the vehicle 100.

In step S501, the control unit 260 detects the vibration state of the vehicle 100, such as the amplitude and frequency of the vibration, by using the self-vehicle condition detecting unit 140. In step S502, the control unit 260 compares the vibration state of the vehicle 100 toa predetermined value. When, as the result of this comparison, the control unit 260 determines that the vibration state affects the range finding accuracy, the process of step S503 is executed. In step S503, the control unit 260 sets the shutter speed S to the value of the corresponding shutter speed Sb, according to the vibration state of the vehicle 100. In contrast, in step S502, the vibration state is compared to a predetermined value, and when the control unit 260 determines that the vibration state does not affect the range finding accuracy, the process of step S505 is executed.

In step S505, the control unit 260 detects the road surface condition in the forward direction by using the road surface condition detecting unit 130. In step S506, the control unit 260 predicts what kind of vibration will be generated based on the information regarding the detected road surface conditions, such as bumps on the road surface, their sizes, the surface conditions (the way in which the road surface is uneven), and their distances. Subsequently, the predicted vibration state is compared to a predetermined value.

In step S506, the predicted vibration state is compared to a predetermined value, and when the control unit 260 determines that vibration that affects the range finding accuracy is predicted, the process of step S503 is executed. The shutter speed S is set to the value of the corresponding shutter speed Sb, according to the predicted occurrence of vibrations . In contrast, in step S506, the predicted vibration state is compared to a predetermined value, and when the control unit 260 determines that the vibration does not affect the range finding accuracy, the process of step S507 is executed. In step S507, the control unit 260 sets the shutter speed S to the shutter speed Sa that is the normal shutter speed.

In step S504, the control unit 260 acquires the image data based on the shutter speed S that was changed in each of step S503 and step S507, and outputs the image data to the distance information generating unit 224.

In step S508, the control unit 260 generates the distance information L by using the distance information generating unit 224 and outputs the distance information L to the distance calculating unit 250. In step S509, the control unit 260 calculates the distance information LL by using the distance calculating unit 250, based on the predetermined image averaged number n.

Here, in the present embodiment, the shutter speed Sb when vibrations occur is set as higher than the normal shutter speed Sa. The resulting effect will now be described.

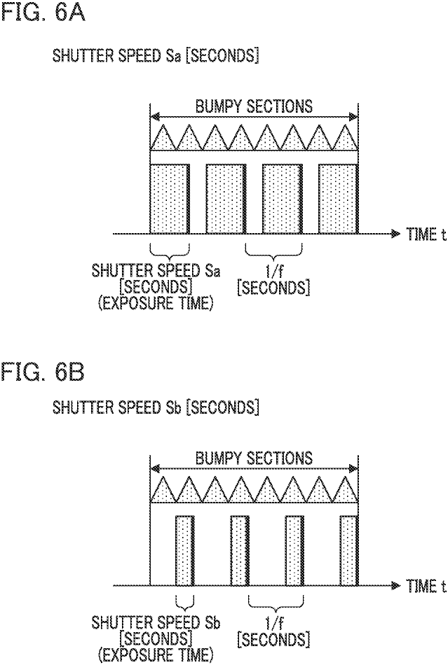

FIG. 6A and FIG. 6B are diagrams showing the relation between the image generation timing (thick line) and the shutter speed at the image output frequency (frame rate) in the bumpy sections on the road. A hatched portion indicates the shutter speed (exposure time). The only difference between FIG. 6A and FIG. 6B is the shutter speed S, and all other conditions are the same.

In FIG. 6A, shutter speed S=shutter speed Sa is set, and, in FIG. 6B, the shutter speed S=shutter speed Sb is set. As was described above, since the shutter speed Sb is higher than the shutter speed Sa, the exposure time at the shutter speed Sb is shorter than the exposure time at the shutter speed Sa.

Here, as described above, even when the shutter speed S is increased, it is possible to perform the range finding using image data with an appropriate exposure amount by adjusting the aperture and the gain. However, increasing the gain too much may cause noise in the image data and affect the range finding accuracy. Therefore, in the present embodiment, the shutter speed Sb is set within a range in which image data can be obtained without affecting the range finding accuracy.

Thus, the shutter speed Sb is set to be higher than the shutter speed Sa, and as a result, the image that is generated at the shutter speed Sb with a shorter exposure time results in an object image with the lowest possible amount of blurring. By generating the distance information using images in which the blurring has been made as low as possible, it is possible to suppress the reduction in the range finding performance .

### Third Embodiment

A method for suppressing reductions in range finding accuracy according to the third embodiment will be described. The same reference numerals are assigned to the configurations that are the same as the configurations of the above-described embodiments,, and descriptions thereof will be omitted. The suppression of reductions in range finding accuracy by changing the shutter speed in the first embodiment, and changing the distance information calculation method in the second embodiment that were described above may be performed independently or in combination. In the present embodiment, a method for suppressing reductions in range finding accuracy by combining changing the distance information calculation method and changing the shutter speed will be explained.

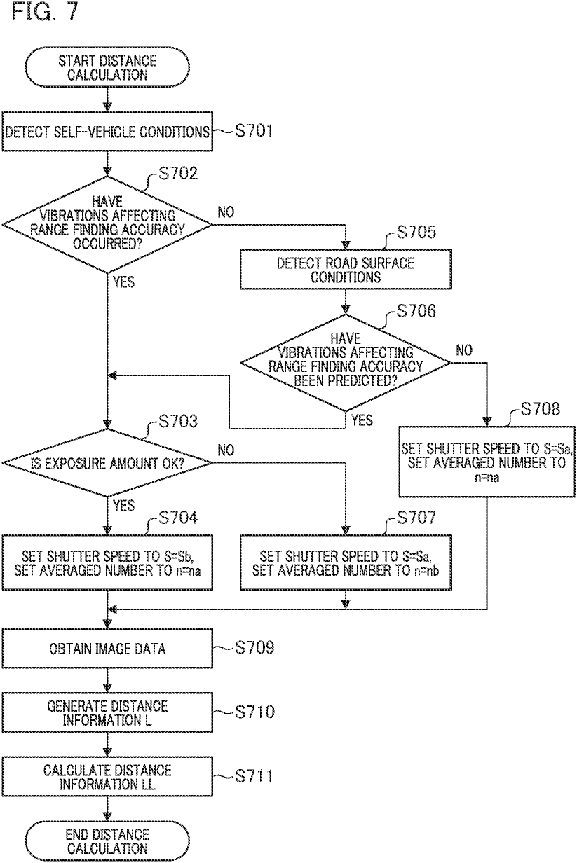

FIG. 7 is a flow chart showing the combination of changing the distance information calculation method and changing the shutter speed according to the third embodiment. Note that, as was described above, the relation of the image averaged numbers n is the condition that the image averaging number na < the image averaged number nb. Additionally, the relation between the shutter speeds S is the condition that the shutter speed Sb is higher than the shutter speed Sa (the exposure time at the shutter speed Sb is shorter than the exposure time at the shutter speed Sa).

In step S701, the control unit 260 detects the vibration states in the vehicle 100, such as the amplitude and frequency of the vibration, using the self-vehicle condition detecting unit 140. In step S702, the control unit 260 compares the vibration state in the vehicle 100 to a predetermined value. When, as the result of the comparison, the control unit 260 determines that the vibration state affects the range finding accuracy, the process of step S703 is executed.

In step S703, the control unit 260 compares the exposure amount for the image data generated by the image processing unit 223 to a predetermined value, and determines whether or not the shutter speed can be increased. Specifically, although the exposure amount is reduced by increasing the shutter speed, the control unit 260 determines whether or not image data that does not affect the distance information calculation can be obtained by adjusting the aperture value and the sensitivity gain of the imaging sensor. In step S703, when the control unit 260 determines that the exposure amount is sufficient to increase the shutter speed, the process of step S704 is executed. In step S704, the control unit 260 sets the shutter speed S to the shutter speed Sb, and sets the image averaged number n to the image averaged number na. In contrast, in step S703, when the control unit 260 determines that the exposure amount is not sufficient to increase the shutter speed, the process of step S707 is executed. In step S707, the shutter speed S is set to the shutter speed Sa, and the image averaged number n is set to the image averaged number nb.

In step S702 described above, when the control unit 260 determines that the vibration state does not affect the range finding accuracy, the process of step S705 is executed. In step S705, the control unit 260 detects the road surface condition in the forward direction using the road surface condition detecting unit 130. Next, in step S706, the control unit 260 predicts what kind of vibration occurs, based on the information regarding the detected road surface conditions, such as bumps on the road surface and their sizes, surface conditions (the way in which the road surface is uneven), distances between them, and the like. Furthermore, the control unit 260 compares the predicted vibration state to a predetermined value. When, s the result of this comparison, the control unit 260 predicts a vibration that will affect the range finding accuracy, the process of step S703 is executed. In contrast, when the control unit 260 does not predict a vibration that will affect the range finding accuracy, the process of step S708 is executed. In step S708, the shutter speed S is set to Sa and the image averaged number n is set to the image averaged number na.

The process of step S709 is executed after step S704, step S707, and step S708. The control unit 260 acquires the image data based on the shutter speeds S each set from the image processing unit 223 and outputs the image data to the distance information generating unit 224.

In step S710, the control unit 260 causes the distance information generating unit 224 to generate the distance information L, and outputs the distance information L to the distance calculating unit 250. In step S711, the control unit 260 calculates the distance information LL based on the image averaged numbers n that have each been set by the distance calculating unit 250.

The effect thereof will now be explained. As was described above, in the case in which the image averaging number n is set to the image averaged number nb (> the image averaged number na), although the reduction in the range finding accuracy can be suppressed, the frequency at which the distance information LL is acquired is reduced. Therefore, when vibrations that affect the range finding accuracy occur or are predicted, and when countermeasures against the occurrence of vibrations can be taken by increasing the shutter speed S, the setting value of only the shutter speed S is changed. In this case, the frequency at which the distance information LL is acquired is not reduced. In contrast, if increasing the shutter speed S is impossible, only the setting value for the image averaged number n is changed. In this case, the frequency at which the distance information LL is acquired is reduced. Therefore, more appropriate settings can be performed according to specific cases.

Note that in the present embodiment, the road surface state and the vibration state of the vehicle 100 are detected by the road surface condition detecting unit 130 and the self-vehicle condition detecting unit 140, and the image averaging number n and the shutter speed S are set according to the detection result, so as to suppress the decrease in the range finding accuracy. However, the conditions to be detected are not limited thereto, and various setting values such as the image averaged number n related to distance calculation and the shutter speed S may also be set based on other conditions. The examples of other conditions include various conditions such as conditions of the road surface including an asphalt road surface and a dirt road surface, or a condition of the air pressure of a tire and a variable damper of the vehicle 10. Specifically, bumps, unevenness, and structures on the road surface, and further, the friction coefficient of the surface, the wet state of the road surface, and the like may be detected by the road surface condition detecting unit 130, and the vibration, rotation, and speed of the vehicle 100 may be detected by the self-vehicle condition detecting unit 140. Additionally, the self-vehicle condition detecting unit 140 may acquire an image of part or all of the vehicle 100, as necessary.

Additionally, the setting values related to distance calculation are not limited to the image averaged number n and the shutter speed S, and the sampling frequency, the range finding range, and the like during the range finding of each range finding device may be used as settings. It is conceivable that, for example, the speed of the vehicle 100 is detected by the self-vehicle condition detecting unit 140, and a setting value related to distance calculation is changed to the image averaged number n or the shutter speed S, between low-speed traveling and high-speed traveling. This will be explained below.

During high-speed traveling, a high frequency is required at the sampling frequency during the range finding (image output frequency (frame rate) f in the above described embodiment). However, when the frequency increases, the processing load also increases. In contrast, when the vehicle is traveling at a high speed on, for example, a highway, an object that is the target for range finding, for example, a vehicle in front of this vehicle, is far away, and the range finding range (distance measurement range) including the angle of field and the angle of view may be small. Accordingly, it is conceivable that the range finding range (In the above-described embodiment, the amount of image data generated by the image processing unit 223) is set to be small when the vehicle is traveling at high speed. In this case, it is possible to increase the sampling frequency for range finding and suppress the increase in the processing load at that time.

Although the present invention has been described in detail based on the preferred embodiments, the present invention is not limited to these specific embodiments, and various forms within a scope that does not exceed the gist of the invention are also included in the present invention. Additionally, some of the above-described embodiments may be combined as appropriate.

In the above-described embodiment, although the control unit 260 changes the parameters related to the averaging processing and the shutter speed based on the vibrations detected by the self-vehicle condition detecting unit 140, the present invention is not limited thereto. The control unit 260 may change the parameters based on, for example, the speed state of the moving object that the self-vehicle condition detecting unit 140 has detected.

Specifically, when the self-vehicle condition detecting unit 140 detects a speed state in which the speed of the moving object is equal to or higher than a predetermined speed, the control unit 260 determines that the speed state affects the range finding accuracy. In this case, the control unit 260 shortens the time interval between items of the distance information used in the averaging processing, that is, the control unit 260 refines the resolution of the distance information in the time direction. Additionally, in this case, the control unit 260 may shorten the length of time in the averaging processing so as to calculate the calculated distance in a shorter time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-036883, filed Mar. 10, 2022, which is hereby incorporated by reference in its entirety.

What is claimed is:

1. A range finding device comprising:
a memory storing instructions; and
a processor executing the instructions causing the range finding device to:
calculate a distance between a moving object and an object;
acquire a road surface condition; and
acquire a running state of the moving object,
wherein the processor calculates the distance from the object according to the road surface condition and the running condition.

2. The range finding device according to claim 1, wherein the processor acquires at least one of a vibration, a rotation, a speed, and an image in the moving object.

3. The range finding device according to claim 1, wherein the processor calculates the distance from the object by using data acquired from at least one of LiDAR, a DAF camera, and a stereo camera.

4. The range finding device according to claim 1, wherein the processor acquires at least one of an irregularity on a road surface, a structure on a road surface, and a friction coefficient on a surface.

5. The range finding device according to claim 1, wherein the processor uses at least one parameter from among a time length of averaging processing, a sampling interval, a frequency of distance measurement, and a distance measurement range, during calculation of the distance from the object.

6. The range finding device according to claim 1,
wherein the processor generates distance information,
wherein the processor calculates a calculated distance by performing averaging processing for the distance information at a given time, and
wherein the processor increases the time interval of the distance information used for the averaging processing if the road surface condition affects range finding accuracy.

7. The range finding device according to claim 6, wherein the processor increases the time length of the averaging processing if the road surface condition affects the range finding accuracy.

8. The range finding device according to claim 1 further comprising:
an imaging unit configured to capture a plurality of images having parallax;
wherein the processor generates distance information based on the plurality of images that have been acquired from the imaging unit;
wherein the processor calculates a calculated distance by performing the averaging processing for the distance information at a given time; and
wherein the processor performs control to shorten the exposure time if the road surface condition affects range finding accuracy.

9. The range finding device according to claim 1,
wherein the processor generates distance information;
wherein the processor calculates a calculated distance by performing the averaging processing for the distance information at a given time;
wherein the processor acquires a speed state of the moving object; and
wherein if the processor determines that the speed state is a state that affects range-finding accuracy, the processor reduces the time interval.

10. The range finding device according to claim 9,
wherein if the processor determines that the speed state is a state that affects the range finding accuracy, the processor reduces the time length for the averaging processing.

11. A control method for a range finding device mounted on a moving object comprising:
acquiring a road surface condition;
acquiring a running state of the moving object; and
calculating a distance from an object according to the road surface condition and the running state.

12. A non-transitory storage medium on which is stored a computer program related to a method for controlling a range finding device mounted on a moving object, the method comprising:
acquiring a road surface condition;
acquiring a running state of the moving object; and
calculating a distance from an object according to the road surface condition and the running state.
